(19) United States
(12) Patent Application Publication
(10) Pub. No.: US 2021/0369070 A1
(43) Pub. Date: Dec. 2, 2021

(54) USER APPARATUS, CLEANING ROBOT INCLUDING THE SAME, AND METHOD OF CONTROLLING CLEANING ROBOT

(71) Applicant: Samsung Electronics Co., Ltd., Suwon-si (KR)

(72) Inventors: Sang Hoon HAN, Suwon-si (KR); Hwan CHANG, Suwon-si (KR)

(21) Appl. No.: 17/285,894

(22) PCT Filed: Oct. 14, 2019
(86) PCT No.: PCT/KR2019/013431

§ 371 Date: Apr. 15, 2021

(30) Foreign Application Priority Data
Oct. 15, 2018 (KR) 10-2018-0122403

(51) Int. Cl. A47L 9/28; A47L 9/00; G05D 1/02; G06F 3/0488; G06F 3/0484

(52) U.S. Cl. CPC A47L 9/2842; A47L 9/2894; A47L 9/2857; A47L 9/2884; A47L 9/2852; A47L 9/2826; G05D 2201/0215; G05D 1/0274; G06F 3/0488; G06F 3/04847; A47L 2201/04; A47L 2201/06; A47L 9/009

(57) ABSTRACT

An aspect of the present disclosure is to provide a user apparatus, a cleaning robot including the same, and a method of controlling the cleaning robot, and more particularly, to a technology in which the cleaning robot learns cleaning information about a cleaning area, and adjusts a suction power of the cleaning robot and a wideness of the cleaning area based on a battery charge amount of the cleaning robot. The cleaning robot includes a dust sucking fan configured to suck dust from a cleaning area; a dust sucking motor configured to rotate the dust sucking fan; a communication interface configured to perform communication with a user apparatus; a storage configured to store a battery charge amount of the cleaning robot that is changed as the cleaning area is cleaned; and a controller configured to calculate a wideness of the cleaning area that can be cleaned with a suction power of the dust sucking fan based on the battery charge amount, and to control the cleaning robot to clean the cleaning area of the calculated wideness with the suction power of the dust sucking fan. The controller may be configured to control the communication interface so that information about the wideness of the cleaning area that can be cleaned by the suction power of the dust sucking fan is transmitted to the user apparatus.

### CROSS-REFERENCE TO RELATED APPLICATIONS

This application is a 371 of International Application No. PCT/KR2019/013431 filed on Oct. 14, 2019, which claims priority to Korean Patent Application No. 10-2018-0122403 filed on Oct. 15, 2018, the disclosures of which are herein incorporated by reference in their entirety.

### BACKGROUND

### 1. Field

The present disclosure relates to a user apparatus, a cleaning robot including the same, and a method of controlling the cleaning robot, and more particularly, to a technology in which the cleaning robot learns cleaning information about a cleaning area, and adjusts a suction power of the cleaning robot and a wideness of the cleaning area based on a battery charge amount of the cleaning robot.

### 2. Description of Related Art

A cleaning robot is a device that automatically cleans a room by sucking up impurities, such as dust on the floor while autonomously moving about the room without user intervention. That is, the cleaning robot cleans the room while moving around the room.

In general, the cleaning robot automatically cleans the room along a route planned in the cleaning robot regardless of an intention of the user. The cleaning robot generates and follows a detour route to avoid an obstacle when detecting the obstacle while moving along the planned route.

The cleaning robot cleans a cleaning space based on a charged battery. When the battery is low during cleaning, the cleaning robot must return to a charging station for charging, and perform a remaining cleaning after charging.

The battery of the cleaning robot is consumed by the cleaning robot moving in a predetermined pattern and by an operation of a dust suction fan by rotation of a dust suction motor. When a suction power of the cleaning robot is operated strongly, a battery consumption is large, so there is a limit to cleaning a large area. Accordingly, there is an increasing need for efficiently cleaning the cleaning space with a current battery charge amount by appropriately adjusting an strength of the suction power and a cleanable area of the cleaning robot.

An aspect of the present disclosure is to provide a cleaning robot that efficiently cleans a cleaning space by appropriately adjusting an strength of suction power of the cleaning robot and an area that can be cleaned based on a battery charge amount of the cleaning robot, and provides a control screen for the user to adjust the strength of suction power and the area to be cleaned.

### SUMMARY

An aspect of the disclosure provides a cleaning robot including:

a dust sucking fan configured to suck dust from a cleaning area; a dust sucking motor configured to rotate the dust sucking fan; a communication interface configured to perform communication with a user apparatus; a storage configured to store a battery charge amount of the cleaning robot that is changed as the cleaning area is cleaned; and a controller configured to calculate a wideness of the cleaning area that can be cleaned with a suction power of the dust sucking fan based on the battery charge amount, and to control the cleaning robot to clean the cleaning area of the calculated wideness with the suction power of the dust sucking fan. The controller may be configured to control the communication interface so that information about the wideness of the cleaning area that can be cleaned by the suction power of the dust sucking fan is transmitted to the user apparatus.

The controller may be configured to calculate the suction power of the dust sucking fan for cleaning an entire area of the cleaning area based on the battery charge amount, and to control the cleaning robot to clean the entire area of the cleaning area based on the calculated suction power.

The controller may be configured to control the communication interface so that information about the suction power of the dust sucking fan calculated to clean the entire area of the cleaning area is transmitted to the user apparatus.

The controller may be configured to divide the cleaning area according to a predetermined reference, to differently set the suction power of the dust sucking fan for each of the divided cleaning areas to clean an entire area of the cleaning area based on the battery charge amount, and to control the cleaning robot to clean each of the divided cleaning areas based on the set suction power.

The communication interface may be configured to receive a cleaning mode control command of the cleaning robot from the user apparatus.

The controller may be configured to: in response to the received cleaning mode being a first mode for cleaning the entire area of the cleaning area, calculate the suction power of the dust sucking fan for cleaning the entire area of the cleaning area based on the battery charge amount, and control the cleaning robot to clean the entire area of the cleaning area based on the calculated suction power.

The controller may be configured to: in response to the received cleaning mode being a second mode for cleaning the cleaning area with a predetermined suction power of the dust sucking fan, calculate a wideness of the cleaning area that can be cleaned with the predetermined suction power based on the battery charge amount, and control the cleaning robot to clean the calculated wideness of the cleaning area with the predetermined suction power.

The storage may be configured to store a battery consumption rate changed in response to a change in suction power of the dust sucking fan, the wideness of the cleaning area changed in response to the change in suction power of the dust sucking fan, and cleaning environment information of the cleaning area. The environmental information of the cleaning area may include at least one of a moving distance of the cleaning robot in response to cleaning the cleaning area based on a state of a floor surface of the cleaning area, an obstacle located in the cleaning area, and the battery charge amount of the cleaning robot.

The controller may be configured to control the cleaning robot to clean the entire area of the cleaning area based on the battery charge amount by controlling to clean the cleaning area by avoiding obstacles located in the cleaning area based on the environmental information of the cleaning area stored in the storage.

Another aspect of the disclosure provides a user apparatus including:

a communication module configured to communicate with a cleaning robot; a display configured to display a suction power of a dust sucking fan of the cleaning robot and a wideness of a cleaning area; and a processor configured to calculate the wideness of the cleaning area that can be cleaned with the changed suction power in response to a change in suction power of the dust sucking fan, or to calculate the suction power of the dust sucking fan for cleaning the changed cleaning area in response to a change in the wideness of the cleaning area to be displayed on the display.

The display may be configured to display the suction power of the dust sucking fan and the wideness of the cleaning area in a form of a progress bar, and to change and display the displayed progress bar in response to a touch command on the process bar input from a user.

The display may be configured to: in response to a change in the display of the suction power of the displayed dust sucking fan according to the touch command input from the user, display the wideness of the cleaning area that can be cleaned in response to the changed suction power based on the battery charge amount of the cleaning robot.

The display may be configured to: in response to a change in the display of the wideness of the displayed cleaning area according to the touch command input from the user, display the suction power of the dust sucking fan that is changed to clean the changed cleaning area with the battery charge amount of the cleaning robot.

The user apparatus may further include an input configured to receive at least one of a control command to change the suction power of the dust sucking fan or a control command to change the wideness of the cleaning area from a user.

The input may be configured to receive a first mode for cleaning an entire area of the cleaning area. In response to the input of the first mode, the processor may be configured to control to be displayed on the display by calculating the suction power of the dust sucking fan for cleaning the entire area of the cleaning area based on the battery charge amount of the cleaning robot.

The input may be configured to receive a second mode for cleaning the cleaning area with a predetermined suction power of the dust sucking fan. In response to the input of the second mode, the processor may be configured to control to be displayed on the display by calculating the wideness of the cleaning area that can be cleaned with the predetermined suction power based on the battery charge amount of the cleaning robot.

The processor may be configured to control the communication module so that wideness information of the cleaning area calculated in response to the change in suction power of the dust sucking fan or suction power information of the dust sucking fan calculated in response to the change in the wideness of the cleaning area is transmitted to the cleaning robot.

Another aspect of the disclosure provides a method of controlling a cleaning robot including:

storing, by a storage, a battery charge amount of the cleaning robot that is changed as a cleaning area is cleaned; calculating, by a controller, a wideness of the cleaning area that can be cleaned with a suction power of a dust sucking fan based on the battery charge amount; controlling, by the controller, the cleaning robot to clean the cleaning area of the calculated wideness with the suction power of the dust sucking fan; and controlling, by the controller, a communication interface so that information about the wideness of the cleaning area that can be cleaned by the suction power of the dust sucking fan is transmitted to the user apparatus.

The method may further include calculating, by the controller, the suction power of the dust sucking fan for cleaning an entire area of the cleaning area based on the battery charge amount; and controlling, by the controller, the cleaning robot to clean the entire area of the cleaning area based on the calculated suction power.

The method may further include controlling, by the controller, the communication interface so that information about the suction power of the dust sucking fan calculated to clean the entire area of the cleaning area is transmitted to the user apparatus.

The method may further include dividing, by the controller, the cleaning area according to a predetermined reference; differently setting, by the controller, the suction power of the dust sucking fan for each of the divided cleaning areas to clean an entire area of the cleaning area based on the battery charge amount; and controlling, by the controller, the cleaning robot to clean each of the divided cleaning areas based on the set suction power.

The method may further include receiving, by the communication interface, a cleaning mode control command of the cleaning robot from the user apparatus.

The method may further include, in response to the received cleaning mode being a first mode for cleaning the entire area of the cleaning area, calculating, by the controller, the suction power of the dust sucking fan for cleaning the entire area of the cleaning area based on the battery charge amount; and controlling, by the controller, the cleaning robot to clean the entire area of the cleaning area based on the calculated suction power.

The method may further include, in response to the received cleaning mode being a second mode for cleaning the cleaning area with a predetermined suction power of the dust sucking fan, calculating, by the controller, a wideness of the cleaning area that can be cleaned with the predetermined suction power based on the battery charge amount; and controlling, by the controller, the cleaning robot to clean the calculated wideness of the cleaning area with the predetermined suction power.

The method may further include storing, by the storage, a battery consumption rate changed in response to a change in suction power of the dust sucking fan, the wideness of the cleaning area changed in response to the change in suction power of the dust sucking fan, and cleaning environment information of the cleaning area. The environmental information of the cleaning area may include at least one of a moving distance of the cleaning robot in response to cleaning the cleaning area based on a state of a floor surface of the cleaning area, an obstacle located in the cleaning area, and the battery charge amount of the cleaning robot.

The method may further include controlling, by the controller, the cleaning robot to clean the entire area of the cleaning area based on the battery charge amount by controlling to clean the cleaning area by avoiding obstacles located in the cleaning area based on the environmental information of the cleaning area stored in the storage.

Based on a current battery charge amount of a cleaning robot, there is an effect of securing an optimum cleaning effect without recharging a battery by adjusting an strength of a suction power and an area that can be cleaned. In addition, by providing information about the strength of the suction power of the cleaning robot and the area available for cleaning, it is possible to control a cleaning to be performed in various cleaning patterns. In addition, there is an effect that a user may control the cleaning robot in an optimal cleaning mode by providing information such as a cleaning area and a cleaning time required to the user.

### BRIEF DESCRIPTION OF THE DRAWINGS

FIG. 1 is a conceptual view illustrating controlling a cleaning robot through a user apparatus according to an embodiment.

FIG. 2 is a control block diagram of a user apparatus and a cleaning robot according to an embodiment.

FIG. 3 is a perspective view illustrating an exterior of a cleaning robot according to an embodiment.

FIG. 4 is a perspective view illustrating an interior of a cleaning robot according to an embodiment.

FIG. 5 is a perspective view illustrating an exterior of a user apparatus according to an embodiment.

FIG. 6 is a view illustrating a case in which a user apparatus is implemented as a mobile device according to an embodiment.

FIG. 7 is a view illustrating a cleaning robot cleaning a cleaning area according to an embodiment.

FIGS. 8 and 9 are conceptual views illustrating a relationship between a suction power of a dust suction fan of a cleaning robot and a cleanable area according to an embodiment.

FIG. 10 is a view illustrating that a cleaning robot performs cleaning on a cleaning area based on a cleaning mode received from a user according to an embodiment.

FIG. 11 is a view illustrating that a cleaning robot performs cleaning on a cleaning area based on a cleaning mode received from a user according to another embodiment.

FIG. 12 is a view illustrating a display of a control screen for controlling a cleaning robot on a user apparatus according to an embodiment.

FIG. 13 is a view illustrating a display screen of a user apparatus when a user changes a suction power of a cleaning robot according to an embodiment.

FIG. 14 is a view illustrating a change in an area of a cleaning area that is changed according to a change in suction power of the cleaning robot in FIG. 13.

FIG. 15 is a diagram illustrating a display screen of a user apparatus when a user changes an area of a cleaning area according to an embodiment.

FIG. 16 is a view illustrating a change in an area of a cleaning area that is changed according to a user's control command input in FIG. 15.

FIG. 17 is a view illustrating that a user inputs a cleaning mode of a cleaning robot according to an embodiment.

FIG. 18 is a view illustrating that a user inputs a cleaning mode of a cleaning robot according to another embodiment.

FIGS. 19 and 20 are views illustrating that cleaning information for cleaning a cleaning area by a cleaning robot is displayed on a user apparatus to provide cleaning information to a user according to an embodiment.

FIG. 21 is a flowchart illustrating a user apparatus and a cleaning control system of a cleaning robot according to an embodiment.

### DETAILED DESCRIPTION

Advantages, features, and methods for achieving them will be understood more clearly when the following embodiments are read with reference to the accompanying drawings.

Embodiments and features as described and illustrated in the present disclosure are only preferred examples, and various modifications thereof may also fall within the scope of the disclosure.

The terminology used herein is for the purpose of describing particular embodiments only and is not intended to limit the present disclosure. It is to be understood that the singular forms “a,” “an,” and “the” include plural references unless the context clearly dictates otherwise.

The terms as used throughout the specification, such as “˜part,” “˜module,” “˜member,” “˜block,” etc., may be implemented in software and/or hardware, and a plurality of “˜parts,” “˜modules,” “˜members,” or “˜blocks” may be implemented in a single element, or a single “˜part,” “˜module,” “˜member,” or “˜block” may include a plurality of elements.

It will be further understood that the term “connect” and its derivatives refer both to direct and indirect connection, and the indirect connection includes a connection over a wireless communication network.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The terms including ordinal numbers like “first” and “second” may be used to explain various components, but the components are not limited by the terms. The terms are only for the purpose of distinguishing a component from another. Thus, a first element, component, region, layer or section discussed below could be termed a second element, component, region, layer or section without departing from the teachings of the present disclosure. Descriptions shall be understood as to include any and all combinations of one or more of the associated listed items when the items are described by using the conjunctive term “˜ and/or ˜,” or the like.

Embodiments of a user apparatus, cleaning robot including the user apparatus, and method for controlling the cleaning robot will now be described in detail with reference to accompanying drawings. Like reference numerals refer to like components throughout the drawings, and thus the related descriptions that overlap will be omitted.

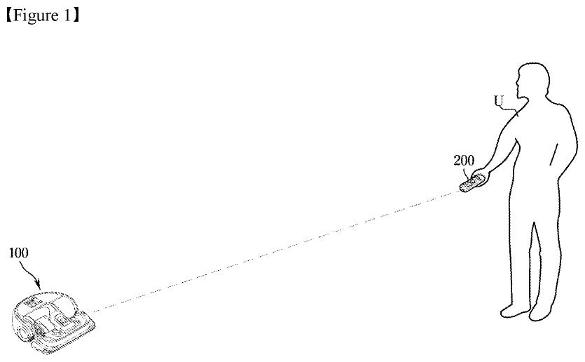

FIG. 1 is a conceptual view illustrating controlling a cleaning robot through a user apparatus according to an embodiment.

Referring to FIG. 1, a user apparatus 200 may be used to transmit a radio communication signal to a cleaning robot 100.

The cleaning robot 100 may clean a room while moving around the room, and the user apparatus 200 may receive an operation command from the user and forward the operation command to the cleaning robot 100 via wireless communication.

The user apparatus 200 may employ a dedicated remote controller manufactured to control the cleaning robot 100 or a portable terminal capable of performing voice communication and data communication with various devices through wireless communication. Various communication schemes, such as Radio Frequency (RF), Wireless Fidelity (Wi-Fi), Bluetooth, Zigbee, near field communication (NFC), Ultra Wide Band (UWB) communications, etc., may be employed for the wireless communication, but are not limited thereto as long as the user apparatus 200 and the cleaning robot 100 may exchange wireless communication signals. Conventionally, the cleaning robot 100 performs automatic cleaning along an internally set cleaning route, and to allow a user U to control the cleaning operation of the cleaning robot 100, the user U may manually set the cleaning robot 100 to be in a manual operation mode and then use a control key or keys on the user apparatus 200 to manually control the cleaning robot 100. Alternatively, the cleaning robot 100 may perform cleaning by moving to follow a light spot originated from a light source of the user apparatus 200.

The cleaning robot 100 may automatically perform cleaning while moving in a predetermined cleaning space according to preset information. In addition, the user may control the cleaning robot 100 through the user apparatus 200 and perform cleaning of the cleaning space. The user may set a moving time, the cleaning area, and a cleaning suction power strength of the cleaning robot 100 through the user apparatus 200.

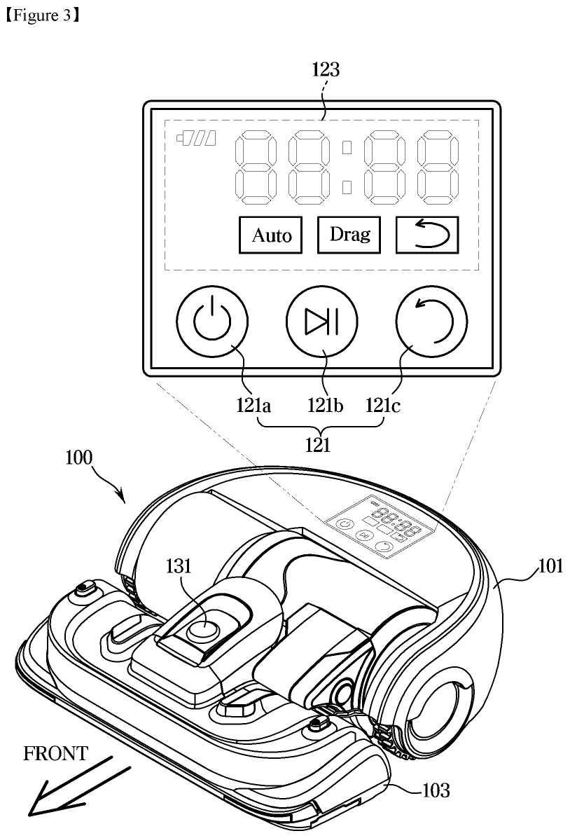

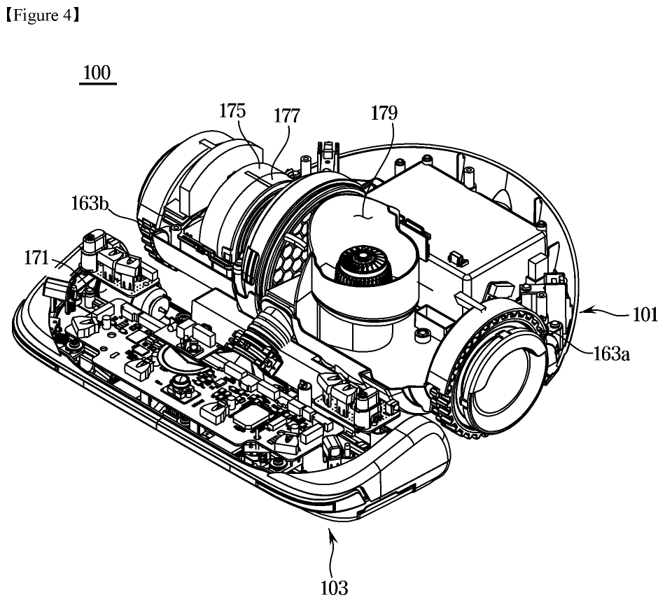

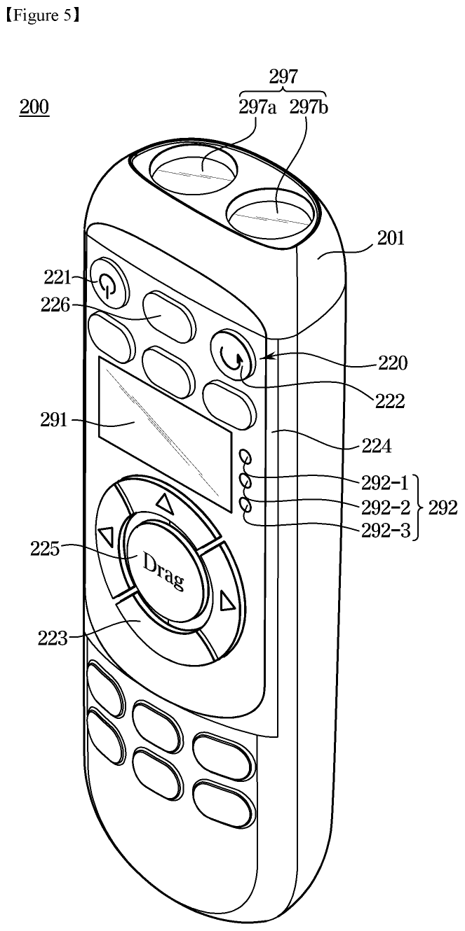

FIG. 3 is a perspective view illustrating an exterior of a cleaning robot according to an embodiment, FIG. 4 is a perspective view illustrating an interior of a cleaning robot according to an embodiment, and FIG. 5 is a perspective view illustrating an exterior of a user apparatus according to an embodiment.

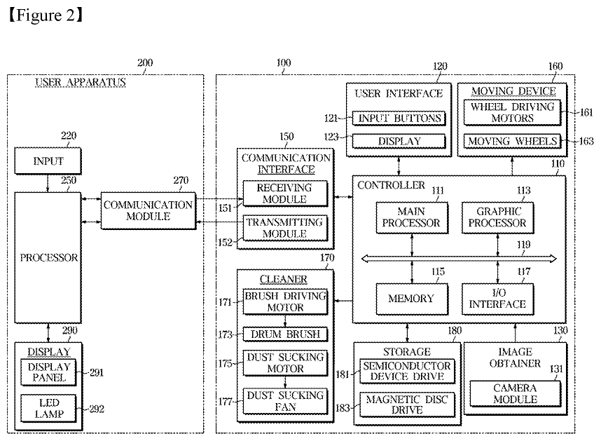

Referring to FIGS. 2 to 4, the cleaning robot 100 may include a main body 101 and a sub body 103. As illustrated in FIG. 3, the main body 101 may be shaped like a semi-circle, and the sub body 103 may be shaped like a rectangle. Inside and outside of the main body 101 and sub body 103, there may be constituent parts for implementing functionalities of the cleaning robot 100.

Particularly, the cleaning robot 100 may include a user interface 120 for interacting with the user, an image obtainer 130 for obtaining surrounding images of the cleaning robot 100, a communication interface 150 for performing wireless communication with the user apparatus 200, a moving device 160 for moving the cleaning robot 100, a cleaner 170 for performing cleaning, a storage 180 for storing programs and various data, and a controller 110 for controlling overall operation of the cleaning robot 100.

The user interface 120 may be arranged on the top face of the main body 101 of the cleaning robot 100, as illustrated in FIG. 3, and may include input buttons 121 for receiving control inputs from the user, and a display 123 for displaying information about operation of the cleaning robot 100.

The input buttons 121 may include a power button 121a for tuning on or off the cleaning robot 100, a start/stop button 121b for starting/stopping operation of the cleaning robot 100, and a return button 121c for returning the cleaning robot 100 to a charging station.

The display 123 may display information of the cleaning robot 100 corresponding to a control command input by the user. For example, the display 123 may display a state of operation of the cleaning robot 100, power state, cleaning mode selected by the user, whether the cleaning robot 100 is returning to the charging station, etc. The state of operation of the cleaning robot 100 may include not only a state of when the cleaning robot 100 is moving to perform cleaning but also a state of whether the cleaning robot 100 has received a radio communication signal related to a control command of the user. The display may display at least one of whether the cleaning robot 100 has received a radio communication signal, whether the cleaning robot 100 is moving, or whether the cleaning robot 100 has arrived at a position where there is the user apparatus 200, which may be transmitted from the cleaning robot 100 to the user apparatus 200.

Although not illustrated, the user interface 120 may include a touch screen panel (TSP) able to receive a control command from the user and display operation information corresponding to the control command in some embodiments.

The image obtainer 130 may include a camera module 131 for obtaining surrounding images of the cleaning robot 100.

The camera module 131 may convert a surrounding image of the cleaning robot 100 to an electric signal that may be processed by the controller 110, and send the electric signal corresponding to an upper image to the controller 110. The image provided by the image obtainer 130 may be used to detect a position of the cleaning robot 100.

The communication interface 150 may include a receiving module 151 for receiving a radio communication signal from the user apparatus 200, and a transmitting module 152 for transmitting a radio communication signal to the user apparatus 200. There may be a single receiving module 151 or a plurality of receiving modules 151 included in the communication interface 150. The receiving module 151 may receive a wireless communication signal transmitted from the user apparatus 200, and the transmitting module 152 may transmit information regarding e.g., a state of operation of the cleaning robot 100 to the user apparatus 200.

Particularly, the user may input a control command related to an operation of the cleaning robot 100 or a call command to move the cleaning robot 100 by means of the user apparatus 200. The input control command or call command may be transmitted from a communication module 270 of the user apparatus 200 in the form of a radio communication signal and received by the receiving module 151 of the cleaning robot 100.

The communication interface 150 may forward the radio communication signal received from the user apparatus 200 to the controller 110. The cleaning robot 100 may perform cleaning under the control of the controller 100.

The cleaning robot 100 may transmit information about a state of operation of the cleaning robot 100 to the user apparatus 100 through the transmitting module 152 of the communication interface 150 under the control of the controller 110, and a receiver 280 of the user apparatus 200 may receive the information and forward it to a processor 250.

Particularly, the transmitting module 152 may transmit information related to a battery charge amount of the cleaning robot 100, learning information obtained by cleaning the cleaning area by the cleaning robot 100, the strength of suction power when the cleaning robot 100 performs cleaning, and the size of the area in which the cleaning robot 100 has performed cleaning to the user apparatus 200.

The communication interface 150 may communicate data with the communication module 270 and the receiver 280 of the user apparatus 200 according to various wired/wireless communication protocols.

The moving device 160 moves the cleaning robot 100 and may include, as illustrated in FIG. 4, wheel driving motors 161, moving wheels 163, and a caster wheel 165.

The moving wheels 163 may be equipped on either ends of the bottom of the main body 101, including left- and right-moving wheels 163a and 163b arranged on the left and right of the cleaning robot 100, respectively, with respect to the front of the cleaning robot 100. The moving wheels 163 may receive turning force from the wheel driving motors 161 to move the cleaning robot 100.

The wheel driving motors 161 may generate turning force to turn the moving wheels 163, and include left- and right-driving motors to turn the left- and right-moving wheels 163a and 163b, respectively.

In addition, the moving device 160 may include a motor driving circuit for supplying a driving current to the wheel driving motor 163 based on a control signal from the controller 110, a power transfer module for transferring turning force of the wheel driving motor 161 to the moving wheel 163, a rotation detection sensor for detecting an angular displacement and rotating speed of the wheel driving motor 161 or moving wheel 163, etc.

The cleaner 170 may include a drum brush 173 for scattering dust on the floor in the cleaning area, a brush driving motor 171 for turning the drum brush 173, a dust sucking fan 177 for sucking in the scattered dust, a dust sucking motor 175 for turning the dust sucking fan 177, and a dust bin 179 for storing the dust sucked.

The drum brush 173 may be mounted in a dust inlet formed on the bottom of the sub body 103 for scattering dust on the floors into the dust inlet while being rotated around the rotation shaft arranged in parallel with the bottom of the sub body 103.

The brush driving motor 171 may be mounted to be adjacent to the drum brush 173 for rotating the drum brush 173 according to a cleaning control signal from the controller 110.

Although not illustrated, the cleaner 170 may further include a motor driving circuit for supplying a driving current to the brush driving motor 171 according to a control signal from the controller 110, and a power transfer module for transferring a turning force of the brush driving motor 171 to the drum brush 173.

The dust sucking fan 177 may be mounted in the main body 101 for sucking the dust scattered by the drum brush 173 into the dust bin 179.

The dust sucking motor 175 may be mounted in a position close to the dust sucking fan 177 for rotating the dust sucking fan 177 according to a control signal from the controller 110.

Although not illustrated, the cleaner 170 may further include a motor driving circuit for supplying a driving current to the dust sucking motor 175 based on a control signal from the controller 110, and a power transfer module for transferring a turning force of the dust sucking motor 175 to the dust sucking fan 177.

As will be described later, as the number of rotations of the dust sucking fan 177 by the dust sucking motor 175 increases, the suction power of the dust sucking fan 177 increases, so that the dust may be strongly sucked. In this way, as the suction power of the dust sucking fan 177 increases, a battery consumption of the cleaning robot 100 increases.

The storage 180 may store a control program and control data to control the cleaning robot 100, and map information of a space to be cleaned, which is obtained while the cleaning robot 100 is moving about.

In addition, the storage 180 may store the amount of battery charge that is changed as the cleaning robot 100 cleans the cleaning area, and store data about the available cleaning area that varies according to the strength of the suction power of the dust sucking fan 177.

In addition, the storage 180 may store the cleaning mode of the cleaning robot 100 that is changed according to a user's setting, and store data about a cleaning pattern, a cleaning time, a cleaning movement distance, and an optimal cleaning method, which are learned as the cleaning robot 100 cleans the cleaning area.

The storage 180 may serve as an auxiliary memory device to assist a memory included in the controller 110 as will be described below, and may be implemented as a non-volatile storage medium that preserves the stored data even when the power to the cleaning robot 100 is out. The storage 180 may include a semiconductor device drive 181 for storing data in a semiconductor device, a magnetic disc drive 183 for storing data in a magnetic disc, etc.

The controller 110 may control overall operation of the cleaning robot 100.

Particularly, the controller 110 may include an input/output (I/O) interface 117 for interfacing data in/out between the controller 110 and the respective components included in the cleaning robot 100, a memory 115 for storing programs and data, a graphic processor 113 for performing image processing, and a main processor 111 for performing computational operation according to the program and data stored in the memory 113. The controller 110 may further include a system bus 119 enabling communication among the main processor 111, the I/O interface 117, the memory 115, and the graphic processor 113.

The I/O interface 117 may receive an image from the image obtainer 130, results of detecting contacts sensed by the contact detector (not shown), etc., and forward them to the main processor 111, the graphic processor 113, and the memory 115 via the system bus 119.

In addition, the I/O interface 117 may forward various control signals output from the main processor 111 to the moving device 160 or cleaner 170.

The memory 115 may store a control program and control data for controlling operation of the cleaning robot 100 by fetching them from the storage 180.

The memory 115 may include volatile memories, such as Static Random Access Memories (S-RAMs), Dynamic RAMs (D-RAMs), or the like. It is, however, not limited thereto, and in some embodiments, the memory 115 may include a non-volatile memory such as a flash memory, a Read Only Memory (ROM), an Erasable Programmable Read Only Memory (EPROM), a Electrically Erasable Programmable Read Only Memory (EEPROM), etc.

The graphic processor 113 may convert an image obtained by the image obtainer 130 into a format to be stored in the memory 115 or storage 180, or may change the resolution or size of the image obtained by the image obtainer 130. Furthermore, the graphic processor 113 may convert a reflected light image obtained by the obstacle detecting module 140 into a format to be processed by the main processor 111.

The main processor 111 may process detection results of a contact detector and images obtained by the image obtainer 130 according to the program and data stored in the memory 115, or perform computational operation to control the moving device 160 and the cleaner 170.

For example, the main processor 111 may calculate a position of the cleaning robot 100, or a direction, a distance and size of the obstacle, based on the image obtained by the image obtainer 130.

Furthermore, the main processor 111 may perform operation to determine whether to avoid or contact the obstacle based on the direction, distance and size of the obstacle. If it is determined to avoid the obstacle, the main processor 111 may calculate a moving route to avoid the obstacle, or otherwise if it is determined to contact the obstacle, the main processor 111 may calculate the moving route to align the cleaning robot 100 with the obstacle.

In addition, the main processor 111 may generate motion control data to be provided to the moving device 160 in order for the cleaning robot 100 to be moved along the calculated moving route.

The controller 110 may control the transmitting module 152 of the communication interface 150 to transmit information about the operation state of the cleaning robot 100 to the user apparatus 200. The controller 110 may control the moving device 160 so that the cleaning robot 100 moves on a cleaning floor.

In addition, the controller 110 may calculate a wideness of the cleaning area that can be cleaned with the suction power of the dust sucking fan 177 based on the battery charge amount of the cleaning robot 100, and control the cleaning robot 100 to clean the cleaning area of the calculated wideness. Similarly, the controller 110 may calculate the suction power of the dust sucking fan 177 for cleaning an entire area of the cleaning area based on the battery charge amount of the cleaning robot 100, and control the cleaning robot 100 to clean the entire area of the cleaning area with the calculated suction power.

Operation of the cleaning robot 100, as will be described below, may be interpreted as operation controlled by the controller 110.

The user apparatus 200 may include a processor 250 for controlling overall operation of the user apparatus 200, an input 220 for receiving control commands for the user apparatus 200 or for the cleaning robot 100 from the user, a communication module 270 for transmitting the wireless communication signal to the cleaning robot 100 and receiving the wireless communication signal from the cleaning robot 100, and a display 290 for displaying a state of operation of the cleaning robot 100.

The user may input a control command to control the UE or cleaning robot 100 through the input 220.

The communication module 270 may transmit a radio communication signal to the cleaning robot 100 based on the control command for the cleaning robot 100 input by the user through the input 220. As described above, various communication schemes, such as Radio Frequency (RF), Wireless Fidelity (Wi-Fi), Bluetooth, Zigbee, near field communication (NFC), Ultra Wide Band (UWB) communications, etc., may be employed for the wireless communication, but are not limited thereto as long as the user apparatus 200 and the cleaning robot 100 may exchange wireless communication signals.

The communication module 270 may receive information about a state of operation of the cleaning robot 100, which is transmitted by the cleaning robot 100, and the display 290 may include at least one of the display panel 291 and the LED lamp to indicate the information about the state of operation of the cleaning robot 100.

In addition, the communication module 270 may transmit data regarding the change in suction power of the dust sucking fan 177 of the cleaning robot 100 or a change in the wideness of the cleaning area input from the user to the cleaning robot 100.

The processor 250 may control overall operation of the user apparatus 200. Particularly, based on the control command for the cleaning robot 100 received from the user through the input 220, the processor 250 may control the communication module 270 to transmit a radio communication signal corresponding to the control command to the cleaning robot 100. Furthermore, based on the information about the state of operation of the cleaning robot 100 received by the communication module 270 from the cleaning robot 100, the processor 250 may control the display 290 to display the state of operation of the cleaning robot 100.

When a user inputs a control command to change the suction power of the dust sucking fan 177 or the control command to change the wideness of the cleaning area through the input 220, the processor 250 may calculate the wideness of the cleaning area that can be cleaned in response to the change in the suction power of the dust sucking fan 177, or may calculate the suction power of the dust sucking fan 177 for cleaning the changed cleaning area in response to the change in the wideness of the cleaning area, and control a calculated value to be displayed on the display 290.

FIG. 5 is a perspective view illustrating an exterior of a user apparatus according to an embodiment.

Referring to FIG. 5, the UE 200 may include the input 220 for receiving a control command from the user, a display panel 291 and LED lamps 292 for indicating the state of operation of the cleaning robot 100.

The input 220 may receive a control command from the user and may be formed in the upper part of the main body 201 that constitutes the exterior of a remote device 200.

The input 220 may include a power button 221 for powering on/off the cleaning robot 100, a return button 222 for returning the cleaning robot 100 to a charging station (not shown) to charge power, a start/stop button 223 for starting or stopping operation of the cleaning robot 100, a plurality of cleaning mode buttons 224 for selecting a cleaning mode of the cleaning robot 100, a call button 226 for inputting a control command to call the cleaning robot 100 to a location of the user, etc. Furthermore, the input 220 may include a drag button 225 for inputting a drag command to move the cleaning robot 100 along a traveling route indicated by the user. In addition, the input 220 may include a button for inputting the control command to change the suction power of the dust sucking fan 177 of the cleaning robot 100 or to change the wideness of the cleaning area that the cleaning robot 100 can clean.

The buttons included in the input 220 may employ push switches for detecting pressure of the user, membrane switches, or touch switches for detecting contacts of a body part of the user.

Also, the input 220 may be implemented on the display panel 291 in the form of the touch panel or the touch screen.

The display panel 291 may display the state of operation of the cleaning robot 100 operating according to the control command input by the user.

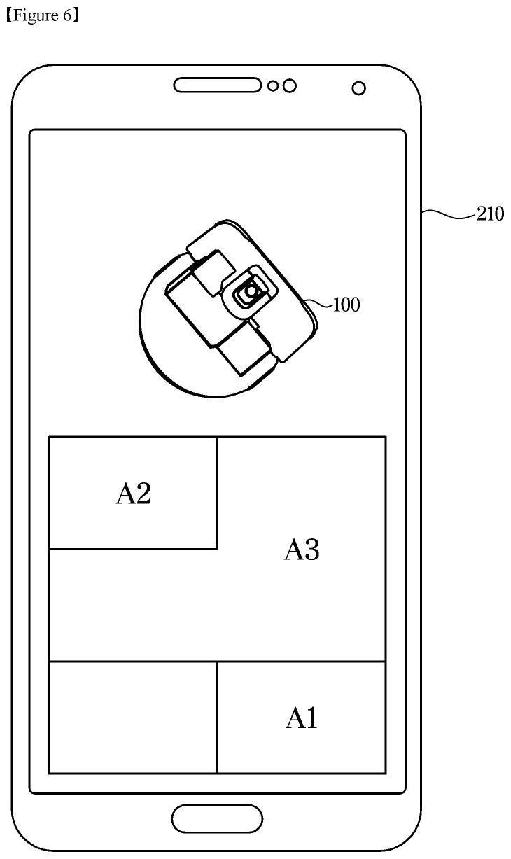

FIG. 6 is a view illustrating a case in which a user apparatus is implemented as a mobile device according to an embodiment.

Unlike in FIG. 5, the user apparatus 200 may be implemented as a mobile device 210 such as a smart phone or a tablet.

That is, the user may control the cleaning robot 100 by installing a dedicated application related to the control of the cleaning robot 100 on the mobile device 210. As described above, the user may input the control command that can be input through the user apparatus 200 through the mobile device 210, and the input control command may be transmitted to the cleaning robot 100 through wireless communication.

In addition, information related to the operation of the cleaning robot 100 and information related to a cleaning performance of the cleaning robot 100 may be displayed on the screen of the mobile device 210. The user may input the control command related to the operation of the cleaning robot 100 based on information displayed on the screen of the mobile device 210, and may input a command for changing the suction power of the dust sucking fan 177 of the cleaning robot 100 or the cleaning area in which the cleaning is performed.

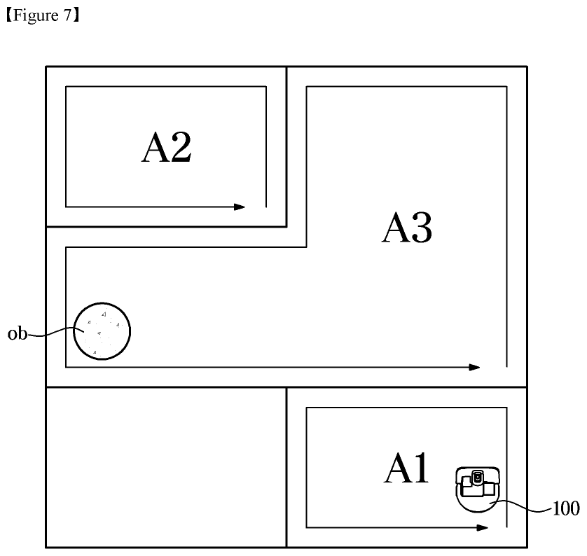

FIG. 7 is a view illustrating a cleaning robot cleaning a cleaning area according to an embodiment.

Referring to FIG. 7, the cleaning robot 100 may move in a preset cleaning area and clean with a preset cleaning pattern. As illustrated in FIG. 7 as an example, when the cleaning area is divided into a first area A1, a second area A2, and a third area A3, the cleaning robot 100 may clean the entire first to third areas A1 to A3, and may clean only some of the first to third areas A1 to A3 according to a predetermined setting.

The cleaning robot 100 may perform cleaning of the cleaning area based on the current battery charge amount. As the cleaning is performed, the battery may be consumed and the and a battery consumption rate may vary depending on the strength of the suction power of the dust sucking fan 177 that sucks the dust in the cleaning area.

An obstacle ob may exist in the cleaning area, and the cleaning robot 100 may perform avoidance driving in a predetermined moving pattern in order to avoid the obstacle ob during cleaning.

As described above, since the amount of battery consumption may increase according to the avoidance driving to avoid the obstacle ob existing in the cleaning area, the cleaning robot 100 may perform driving not close to the cleaning area where the obstacle ob exists in order to clean the entire cleaning area while reducing the current battery consumption rate.

The cleaning robot 100 may clean the cleaning area and store information about the obtained cleaning area in the storage 180, learn the cleaning pattern, and select an optimal cleaning method based on the learned cleaning pattern.

That is, the cleaning robot 100 may learn the moving time and a movement distance required to move the cleaning area, and when the cleaning is performed with a preset suction power of the dust sucking fan 177, the information about the wideness of the cleaning area that can be cleaned by the battery charge amount of the cleaning robot 100 may be learned.

The cleaning robot 100 may perform the cleaning by adjusting the suction power strength or the cleaning area of the dust sucking fan 177 based on pre-learned cleaning information according to the cleaning mode input from the user.

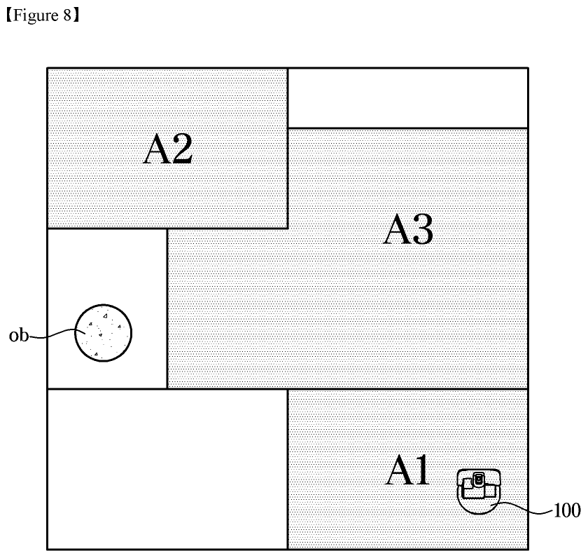

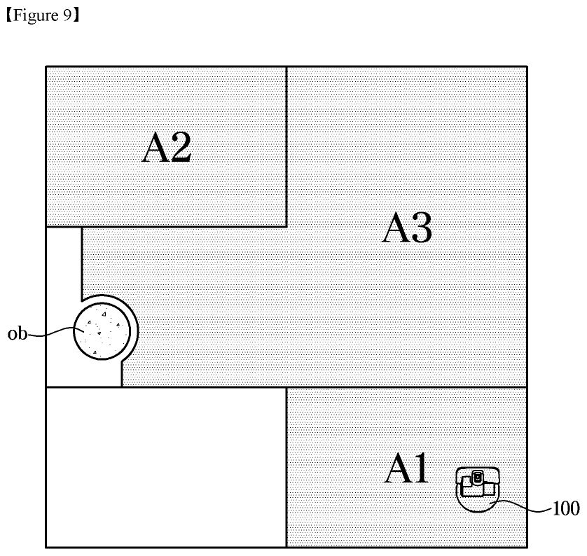

FIGS. 8 and 9 are conceptual views illustrating a relationship between a suction power of a dust suction fan of a cleaning robot and a cleanable area according to an embodiment.

Referring to FIG. 8, when the suction strength of the dust sucking fan 177 of the cleaning robot 100 increases, as the battery consumption rate increases, the area of the cleanable area may decrease. That is, when the suction strength of the dust sucking fan 177 of the cleaning robot 100 increases, the cleaning robot 100 may clean the first area A1 and the second area A2 of the cleaning space, but cannot clean the entire area of the third area A3.

When the suction power strength of the dust sucking fan 177 is strong, since the battery consumption rate increases, the cleaning robot 100 cannot clean the same area with suction power of the same strength. Therefore, the cleaning robot 100 may reduce the suction power of the dust sucking fan 177 in order to clean the entire area of the cleaning space.

Referring to FIG. 9, when the suction strength of the dust sucking fan 177 of the cleaning robot 100 decreases than in FIG. 8, the battery consumption rate may decrease, and thus the area of the cleanable area may increase. That is, when the suction strength of the dust sucking fan 177 of the cleaning robot 100 decreases, the cleaning robot 100 may clean the first area A1 and the second area A2, which are cleaning spaces, and may also clean a larger area than in FIG. 8 in the third area A3.

That is, the cleaning area of the cleaning space may increase according to the suction power strength of the dust sucking fan 177 of the cleaning robot 100, and the cleaning robot 100 may store a relationship between the suction power strength of the dust sucking fan 177 obtained while performing cleaning and the area of the cleaning area in the storage 180.

The cleaning robot 100 may adjust the suction power strength of the dust sucking fan 177 according to the preset cleaning mode, and may self-adjust the cleanable area based on the battery charge amount.

In addition, the cleaning robot 100 may transmit information about the area of the cleaning area according to the suction power strength of the current dust sucking fan 177 based on the battery charge amount through the communication interface 150.

The controller 110 of the cleaning robot 100 may calculate the wideness of the cleaning area that can be cleaned with the suction power of the dust sucking fan 177 based on the battery charge amount of the cleaning robot 100, and may control the moving device 160 and the cleaner 170 to clean the area with the calculated wideness cleaning area with the suction power of the current dust sucking fan 177.

In this case, the controller 110 may transmit information about the wideness of the cleaning area that can be cleaned by the suction power of the dust sucking fan 177 to the user apparatus 200 through the communication interface 150.

In addition, the controller 110 may calculate the suction power of the dust sucking fan 177 for cleaning the entire area of the cleaning area based on the battery charge amount of the cleaning robot 100, and may control the moving device 160 and the cleaner 170 to clean the entire area of the cleaning area based on the calculated suction power.

That is, the controller 110 may reduce the suction power of the dust sucking fan 177 from a preset value in order to clean all of the first area A1 to the third area A3 of the cleaning space with the current battery charge amount of the cleaning robot 100.

In this case, the controller 110 may control the communication interface 150 so that information about the suction power of the dust sucking fan 177 calculated to clean the entire area of the cleaning area is transmitted to the user apparatus 200. .

As described above, the controller 110 of the cleaning robot 100 may adjust the suction power strength of the dust sucking fan 177 or the wideness of the cleaning area for performing cleaning based on the battery charge amount of the cleaning robot 100.

The controller 110 may divide the cleaning area according to a predetermined reference, and differently set the suction power of the dust sucking fan 177 for each of the divided cleaning areas in order to clean the entire area of the cleaning area based on the battery charge amount of the cleaning robot 100. The controller 110 may control the cleaning robot 100 to clean each of the divided cleaning areas based on the suction power set differently for each cleaning area.

That is, based on the current battery charge amount of the cleaning robot 100, when cleaning the first area A1 to the third area A3 of the cleaning space with the same suction power strength, since the entire third area A3 cannot be cleaned, the controller 110 may perform cleaning by differently setting the suction power of the dust sucking fan 177 for each of the divided first to third areas A1 to A3.

For example, the controller 110 may control the cleaning of the cleaning robot 100 by setting the suction power of the dust sucking fan 177 strongly for the first area A1 and the second area A2, and by setting the suction power of the dust sucking fan 177 weakly for the third area A3, thereby controlling the moving device 160 and the cleaner 160 to perform cleaning for the entire first area A1 to the third area A3.

In addition, when the battery charge amount of the cleaning robot 100 is not sufficient for cleaning the entire area, as described above, in order to reduce the amount of battery consumption consumed from avoiding moving to avoid the obstacle ob located in the cleaning area, the controller 110 may move the moving device 160 so that the cleaning robot 100 does not come close to the area where the obstacle ob is located.

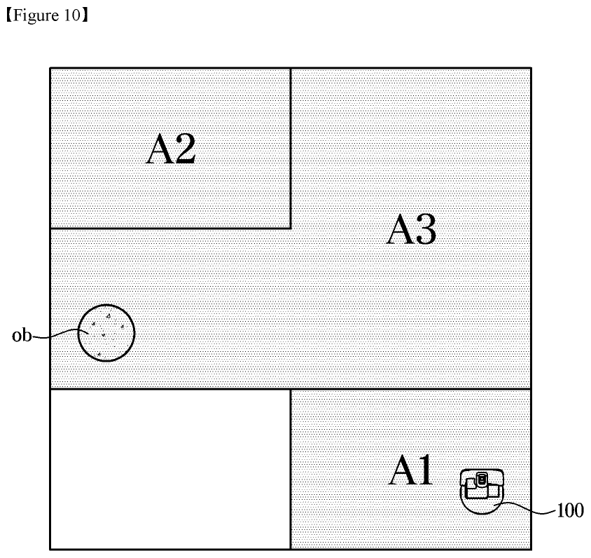

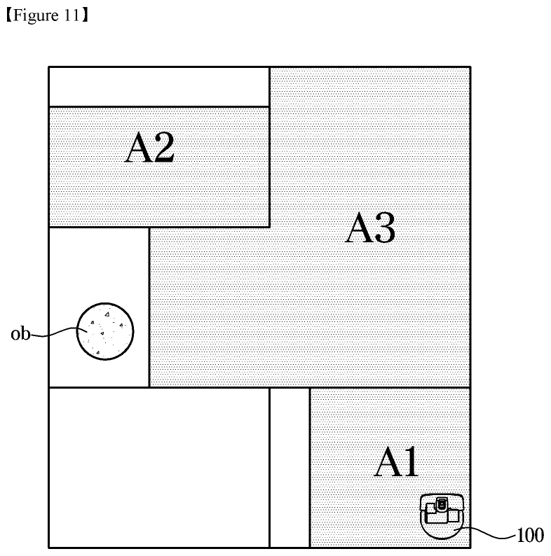

FIG. 10 is a view illustrating that a cleaning robot performs cleaning on a cleaning area based on a cleaning mode received from a user according to an embodiment, and FIG. 11 is a view illustrating that a cleaning robot performs cleaning on a cleaning area based on a cleaning mode received from a user according to another embodiment.

The communication interface 150 of the cleaning robot 100 may receive a cleaning mode control command of the cleaning robot 100 from the user apparatus 200.

The user may input the cleaning mode of the cleaning robot 100 through the user apparatus 200. The cleaning mode of the cleaning robot 100 may vary according to various information such as the suction power strength, the cleaning area, the cleaning time, and the movement distance of the dust sucking fan 177.

The user may select the cleaning mode of the cleaning robot 100 based on the cleaning information received from the cleaning robot 100 by the user apparatus 200. That is, based on information about the amount of battery charge received by the user apparatus 200 from the cleaning robot 100, information about the suction power of the dust sucking fan 177, information about the area of the cleaning area that can be cleaned with the preset suction power, etc., the user may input the cleaning mode of the cleaning robot 100.

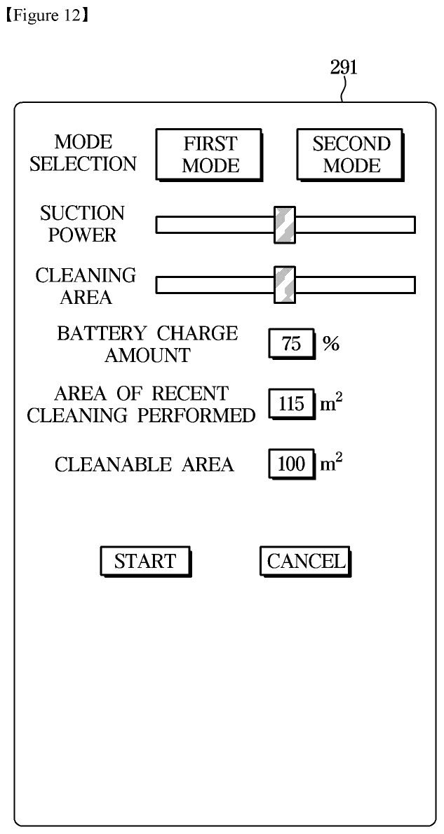

Specific embodiments in which the cleaning information transmitted by the cleaning robot 100 to the user apparatus 200 and the user inputs the control command for the cleaning robot 100 through the user apparatus 200 will be described later in FIGS. 12 to 20. .

The user may input a control command for a ‘first mode’ that cleans the entire area of the cleaning area based on the current battery charge amount of the cleaning robot 100 through the user apparatus 200.

The ‘first mode’ may be a cleaning mode in which cleaning of the entire area of the cleaning space is performed without recharging based on the current battery charge amount of the cleaning robot 100, and since a coverage for the entire area of the cleaning space should be given prioritized, the controller 110 of the cleaning robot 100 may adjust the suction power of the dust sucking fan 177.

That is, upon receiving the control command for the first mode from the user apparatus 200, the controller 110 of the cleaning robot 100 may calculate the suction power of the dust sucking fan 177 to clean the entire area of the cleaning area based on the current battery charge amount, and may control the cleaning robot 100 to clean the entire area of the cleaning area based on the calculated suction power.

As illustrated in FIG. 10, the cleaning robot 100 may clean the entire area of the first area A1 to the third area A3 based on the calculated suction power of the dust sucking fan 177.

In this case, since the control to clean the entire area of the cleaning area is prioritized rather than the strength of the suction power of the dust sucking fan 177 of the cleaning robot 100, and the controller 110 may reduce the battery consumption rate by decreasing the suction power strength of the dust sucking fan 177 than the preset value, and the same time clean the entire area of the cleaning area.

The user may input a control command for a ‘second mode’ for cleaning the cleaning area with a predetermined suction power based on the current battery charge amount of the cleaning robot 100 through the user apparatus 200.

The ‘second mode’ is the same as the ‘first mode’ in that cleaning of the cleaning area is performed without recharging based on the current battery charge amount of the cleaning robot 100, but unlike the first mode, the coverage for the entire area is not prioritized. In the second mode, since the cleaning area is cleaned by maintaining the strength of the suction power of the dust sucking fan 177, the controller 110 of the cleaning robot 100 may adjust the wideness of the cleaning area capable of performing cleaning.

That is, upon receiving the control command for the second mode from the user apparatus 200, the controller 110 of the cleaning robot 100 may calculate the wideness of the cleaning area that can be cleaned with the predetermined suction power based on the current battery charge amount, and may control the cleaning robot 100 to clean the cleaning area of the calculated wideness with the predetermined suction power.

As illustrated in FIG. 11, the cleaning robot 100 may clean the cleaning area of the wideness calculated in response to the predetermined suction power of the dust sucking fan 177.

In the embodiment of FIG. 10, in order for the cleaning robot 100 to clean the entire area of the cleaning area, the suction power strength of the cleaning suction fan 177 of the cleaning robot 100 may be adjusted based on the battery charge amount. In this case, since a purpose is to perform cleaning with the suction power of the dust sucking fan 177 set in advance even if the entire area of the cleaning area is not cleaned, the wideness of the cleaning area that can be cleaned may be adjusted according to the suction power set value of the dust sucking fan 177.

That is, even if the cleaning robot 100 does not clean the entire area of the cleaning area, the user may set the suction strength of the dust sucking fan 177 to a specific value so that the dust sucking fan 177 performs cleaning with the suction power of a certain strength or higher. Accordingly, the cleaning area of the cleaning robot 100 may be reduced.

The suction power strength of the dust sucking fan 177 of the cleaning robot 100 may be set differently according to the user's setting or learning according to the cleaning performance of the cleaning robot 100.

As described above, the control command for the cleaning mode of the cleaning robot 100 inputted by the user through the user apparatus 200 may be transmitted to the communication interface 150. The controller 110 of the cleaning robot 100 may control the cleaning operation of the cleaning robot 100 based on the control command received by the communication interface 150. In addition, cleaning information learned according to the cleaning performance of the cleaning robot 100 may be stored in the storage 180, and the learning information may be transmitted to the user apparatus 200 through the communication interface 150.

The storage 180 of the cleaning robot 100 may store the battery consumption rate that is changed in response to the change in suction power of the dust sucking fan 177, the wideness of the cleaning area that is changed in response to the change in suction power of the dust sucking fan 177, and cleaning environment information of the cleaning area. At this time, the stored environmental information of the cleaning area may include at least one of the movement distance of the cleaning robot 100 to clean the cleaning area based on a state of a floor surface of the cleaning area, obstacles located in the cleaning area, and the battery charge amount of the cleaning robot 100.

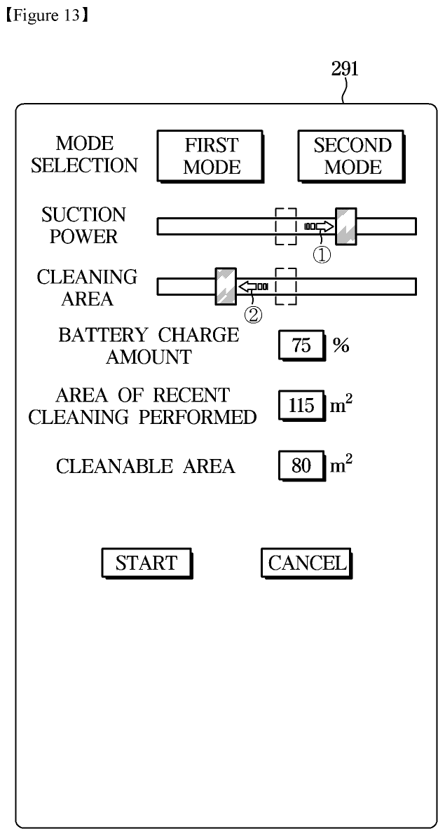

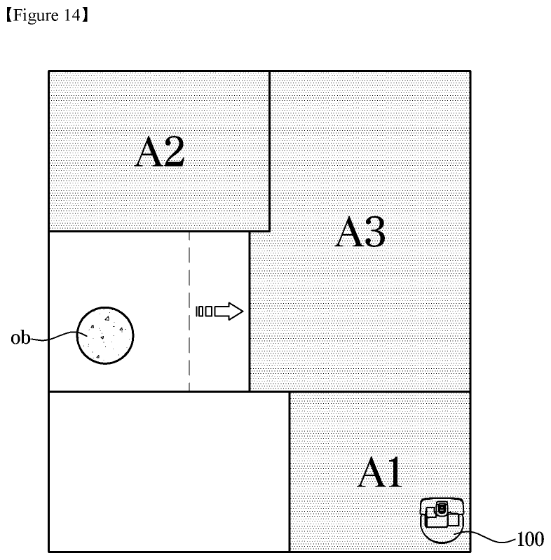

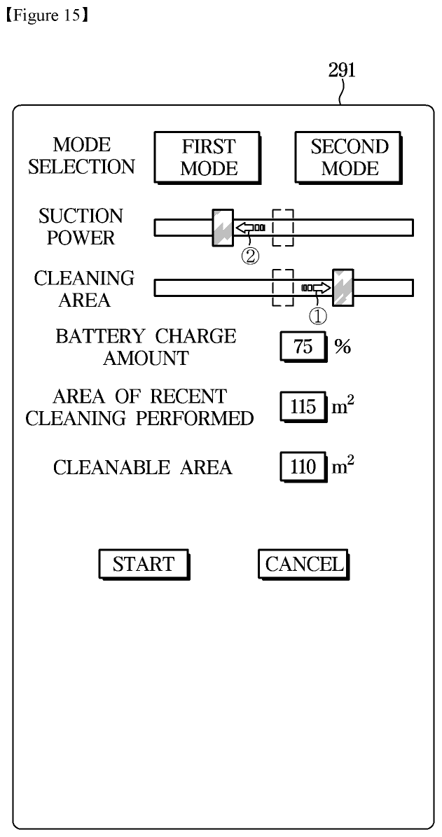

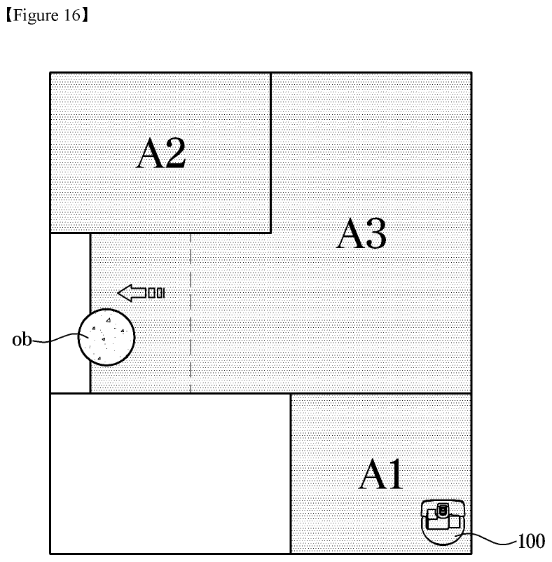

FIG. 12 is a view illustrating a display of a control screen for controlling a cleaning robot on a user apparatus according to an embodiment, FIG. 13 is a view illustrating a display screen of a user apparatus when a user changes a suction power of a cleaning robot according to an embodiment, FIG. 14 is a view illustrating a change in an area of a cleaning area that is changed according to a change in suction power of the cleaning robot in FIG. 13, FIG. 15 is a diagram illustrating a display screen of a user apparatus when a user changes an area of a cleaning area according to an embodiment, and FIG. 16 is a view illustrating a change in an area of a cleaning area that is changed according to a user's control command input in FIG. 15.

Referring to FIG. 12, as described above, the cleaning robot 100 may transmit the cleaning information obtained as cleaning of the cleaning space is performed to the user apparatus 200, and the received cleaning information may be displayed on the display 290 of the user apparatus 200.

That is, the communication module 270 of the user apparatus 200 may communicate with the cleaning robot 100 to receive information about the suction power of the dust sucking fan 177 of the cleaning robot 100 and the area of the cleaning area.

In addition, the communication module 270 may receive information about the current battery charge amount of the cleaning robot 100 in operation, information about the area of the cleaning area that the cleaning robot 100 recently cleaned, and information about the cleanable area from the cleaning robot 100 based on the suction power of the currently set dust sucking fan 177.

The display 290 of the user apparatus 200 may display the received cleaning operation information of the cleaning robot 100, and the user may input the control command for the cleaning robot 100 by touching the display panel 291 of the display 290.

The user may input the control command of the cleaning robot 100 through the input 220 or may input the control command through the display panel 291 implemented as the touch panel.

The display 290 of the user apparatus 200 may display the suction power strength of the dust sucking fan 177 of the cleaning robot 100 and the wideness of the cleaning area in a form of a progress bar. The user may adjust the suction power strength of the dust sucking fan 177 or the wideness of the cleaning area by adjusting a progress bar displayed on the display 290.

Referring to FIG. 13, the user may adjust the suction power strength of the cleaning suction fan 177 of the cleaning robot 100 by touching the progress bar displayed on the display panel 291 of the user apparatus 200, and may adjust the area of the cleaning area in which the cleaning robot 100 performs cleaning.

As illustrated in FIG. 13, when the user inputs a control command for increasing the suction power of the dust sucking fan 177 (\textcircled{1}), the processor 250 may calculate the wideness of the cleaning area that can be cleaned with the changed suction power in response to the change in the suction power of the dust sucking fan 177 (\textcircled{2}).

FIG. 13 illustrates that the area of the cleaning area of the cleaning robot 100 decreases as the user increases the suction power of the dust sucking fan 177, on the display 290. Conversely, in FIG. 13, it may be illustrated that the area of the cleaning area of the cleaning robot 100 increases as the user decreases the suction power of the dust sucking fan 177.

As described above, based on the battery charge amount of the cleaning robot 100, since the area of the cleaning area that can be cleaned with the same battery charge amount decreases when the strength of the suction power of the dust sucking fan 177 increases, the processor 250 of the user apparatus 200 may calculate the area of the cleaning area that can be cleaned in response to the increase in the suction power strength of the dust sucking fan 177, and may display the calculated area of the cleaning area on the display 290.

Also, as the area of the cleanable area calculated by the processor 250 decreases, the ‘cleanable area’ displayed on the display 290 may be displayed as a reduced area. The user may identify the cleaning area displayed on the display 290 and identify how much of the available cleaning area is changed as the suction power strength of the dust sucking fan 177 is changed.

In this way, as the user adjusts the suction strength of the dust sucking fan 177 of the cleaning robot 100 through the user apparatus 200, the cleaning area in which the cleaning robot 100 can perform cleaning is varied, and thus, based on the battery charge amount of the cleaning robot 100, the cleaning may be performed without recharging at the strength of the set suction power.

The information about the suction power strength of the dust sucking fan 177 input through the user apparatus 200 and the area of the cleaning area changed in response thereto may be transmitted through the communication module 270 and transmitted to the controller 110 through the communication interface 150 of the cleaning robot 100.

The controller 110 of the cleaning robot 100 may control the moving device 160 and the cleaner 170 to perform cleaning of the cleaning area based on the received information.

Referring to FIG. 14, as the user increases the suction power strength of the dust sucking fan 177 through the user apparatus 200, the controller 110 of the cleaning robot 100 may control the cleaning to be performed by reducing the cleanable area for the third area A3 of the cleaning space.

As illustrated in FIG. 15, when the user inputs the control command for increasing the cleaning area of the cleaning robot 100 (\textcircled{1}), the processor 250 may calculate the suction power of the dust sucking fan 177 for cleaning the increased cleaning area by the cleaning robot 100 in response to the change in the wideness of the cleaning area (\textcircled{2}).

In FIG. 15, as the user increases the cleaning area, the suction power of the dust sucking fan 177 which is reduced to clean the increased cleaning area, based on the current battery charge amount is displayed on the display 290. Conversely, as the user decreases the cleaning area, it may be indicated that the suction power of the dust sucking fan 177 increases.

As described above, based on the battery charge amount of the cleaning robot 100, the suction power strength of the dust sucking fan 177 and the area of the cleaning area that can be cleaned by the cleaning robot 100 are in inverse proportion.

As described above, based on the battery charge amount of the cleaning robot 100, when the area of the cleaning area in which the cleaning robot 100 should perform cleaning increases, as the area of the cleaning area increases, the strength of the dust sucking fan 177 that can rotate with the same battery charge amount decreases, so the processor 250 of the user apparatus 200 may calculate the suction power strength of the dust sucking fan 177 to be reduced in response to the increase in the area of the cleaning area, and may display the calculated suction power strength on the display 290.

In addition, when the user inputs a command to increase the cleaning area of the cleaning robot, the ‘cleanable area’ displayed on the display 290 may be displayed as an increased area.

The user may identify the cleaning area displayed on the display 290 and the strength of the suction power of the dust sucking fan 177, and may identify the strength of the suction power that is reduced in order for the cleaning robot 100 to clean the increased cleaning area.

In this way, as the user adjusts the cleaning area to be cleaned by the cleaning robot 100 through the user apparatus 200, since the suction power of the dust sucking fan 177 is variable, the cleaning robot 100 may clean the cleaning area set by the user without recharging with the strength of the changed suction power based on the current battery charge amount.

The information about the area of the cleaning area input through the user apparatus 200 and the information about the suction power strength of the dust sucking fan 177 changed in response thereto may be transmitted through the communication module 270 and transmitted to the controller 110 through the communication interface 150 of the cleaning robot 100.

The controller 110 of the cleaning robot 100 may control the moving device 160 and the cleaner 170 so that the cleaning is performed with a variable suction power for the cleaning area set by the user based on the received information.

Referring to FIG. 16, as the user inputs the control command to increase the cleaning area of the cleaning robot 100 through the user apparatus 200, the controller 110 of the cleaning robot 100 may control the cleaning to be performed by increasing the cleanable area for the third area A3 of the cleaning space. In this case, in order to increase the cleanable area for the third area A3, the controller 250 may reduce the suction power of the dust sucking fan 177 with the suction power calculated in advance.

In this way, the user may intuitively identify the information about the suction power of the dust sucking fan 177 displayed on the user apparatus 200 and the information about the cleanable area of the cleaning space, and may effectively control the cleaning of the cleaning robot 100 by inputting the control command for adjusting the suction power or the cleaning area.

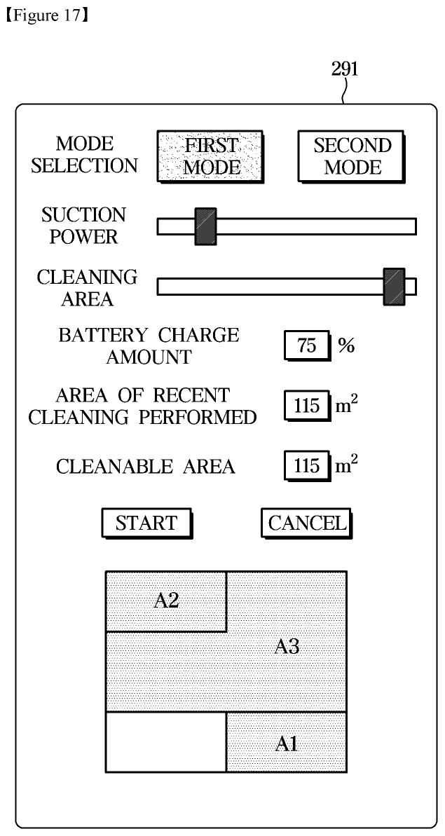

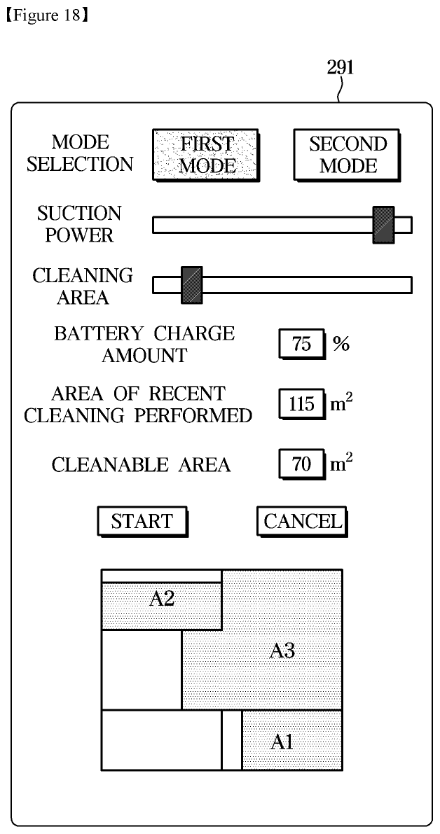

FIG. 17 is a view illustrating that a user inputs a cleaning mode of a cleaning robot according to an embodiment, and FIG. 18 is a view illustrating that a user inputs a cleaning mode of a cleaning robot according to another embodiment.

As illustrated in FIGS. 17 and 18, the display 290 of the user apparatus 200 may display a selection button for the cleaning mode of the cleaning robot 100, and the user may directly input the command through the input 220 or may input the cleaning mode by touching the display panel 291.

Referring to FIG. 17, as described above in FIG. 10, the user may input the control command for the ‘first mode’ that cleans the entire area of the cleaning area based on the current battery charge amount of the cleaning robot 100 through the user apparatus 200.

As illustrated in FIG. 17, when the user selects the ‘first mode’ displayed on the display panel 291 of the user apparatus 200, the processor 250 may determine the strength of the suction power of the dust sucking fan 177 set in the ‘first mode’ and the area of the cleanable area to be displayed on the display 290.

That is, when the user apparatus 200 receives the ‘first mode’ through the input 220 or the display panel 291, the processor 250 may control to be displayed on the display 290 by calculating the suction power of the dust sucking fan 177 for cleaning the entire area of the cleaning area based on the battery charge amount of the cleaning robot 100.

The ‘first mode’ may be the cleaning mode in which cleaning of the entire area of the cleaning space is performed without recharging based on the current battery charge amount of the cleaning robot 100.

Therefore, in the case of the first mode, the coverage of the entire area of the cleaning space cleaned by the cleaning robot 100 should be given priority, and the controller 110 of the cleaning robot 100 may display the progress bar for the entire area of the cleaning space, and control the display 290 to display the suction power strength of the dust sucking fan 177 calculated corresponding thereto.

As illustrated in FIG. 17, when the ‘first mode’ displayed on the display 290 is selected, the entire area of the cleaning area for the cleaning robot 100 to perform cleaning may be displayed on the display 290.

In addition, the processor 250 may transmit the information about the strength of suction power and the area of the cleaning area according to the selection of the first mode to the cleaning robot 100 through the communication module 270.

When the communication interface 150 receives the control command for the first mode from the user apparatus 200, the controller 110 of the cleaning robot 100 may control the cleaning robot 100 to clean the entire area of the cleaning area based on the suction power of the dust sucking fan 177 calculated to clean the entire area of the cleaning area based on the current battery charge amount.

Referring to FIG. 18, as described above in FIG. 11, the user may input the control command for the ‘second mode’ for cleaning the cleaning area with the predetermined suction power based on the current battery charge amount of the cleaning robot 100 through the user apparatus 200.

As illustrated in FIG. 18, when the user selects the ‘second mode’ displayed on the display panel 291 of the user apparatus 200, the processor 250 may determine the strength of the suction power of the dust sucking fan 177 set in the ‘first mode’ and the area of the cleanable area to be displayed on the display 290.

That is, when the user apparatus 200 receives the ‘second mode’ through the input 220 or the display panel 291, the processor 250 may control to be displayed on the display 290 by calculating the wideness of the cleaning area that can be cleaned with the predetermined suction power based on the battery charge amount of the cleaning robot 100.

The ‘second mode’ is the same as the ‘first mode’ in that cleaning of the cleaning area is performed without recharging based on the current battery charge amount of the cleaning robot 100, but unlike the first mode, the coverage for the entire area is not prioritized. The second mode may be the mode in which cleaning of the cleaning area is performed by maintaining the strength of the suction power of the dust sucking fan 177 set in advance.

Therefore, in the case of the second mode, the suction power of the dust sucking fan 177 should be prioritized in the cleaning of the cleaning robot 100, and the processor 250 of the user apparatus 200 may display the progress bar for the strength of the suction power of the cleaning robot 100 and control the display 290 to display the cleaning area of the cleaning area calculated corresponding thereto.

As illustrated in FIG. 18, when the ‘second mode’ displayed on the display 290 is selected, the area of the cleaning area that can be cleaned with the suction power of the preset dust sucking fan 177 may be displayed on the display 290. That is, unlike the ‘first mode’ described in FIG. 17, in the ‘second mode’, as the strength of the suction power of the dust sucking fan 177 of the cleaning robot 100 has increased, the area of the cleanable area of the cleaning space may be decreased and displayed.

In addition, the processor 250 may transmit the information about the strength of suction power and the area of the cleaning area according to the selection of the first mode to the cleaning robot 100 through the communication module 270.

When the controller 110 of the cleaning robot 100 receives the control command for the second mode from the user apparatus 200, the controller 110 of the cleaning robot 100 may control the cleaning robot 100 to clean the cleaning area of the calculated wideness to perform cleaning with the predetermined suction power based on the current battery charge amount with the predetermined suction power.

As described above, in the case of inputting the ‘first mode’ disclosed in FIG. 17, the ‘cleanable area’ is 115 m2, whereas in the case of inputting the ‘second mode’ disclosed in FIG. 18, the ‘cleanable area’ is 70 m2.

That is, as the user inputs the control command that prioritizes the strength of the cleaning suction power of the cleaning robot 100 through the user apparatus 200 or inputs the control command that prioritizes cleaning the entire area of the cleaning area, the cleaning operation of the cleaning robot 100 may be different.

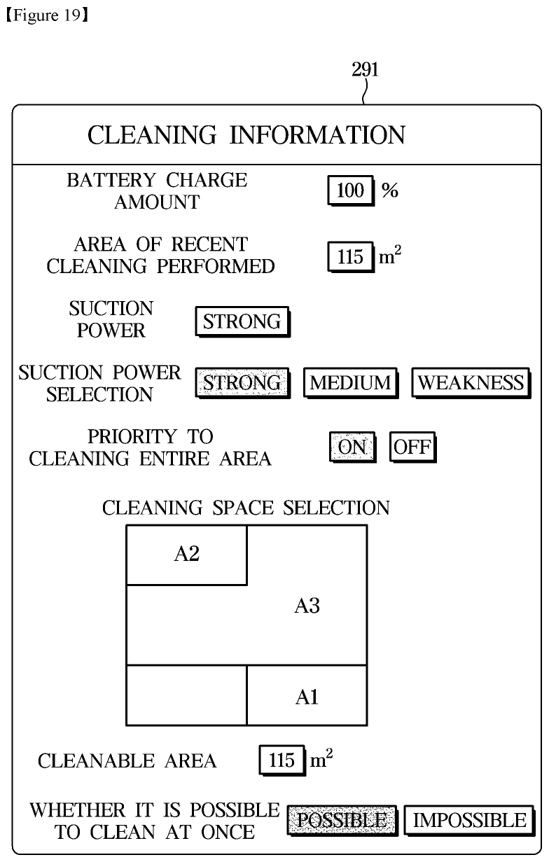

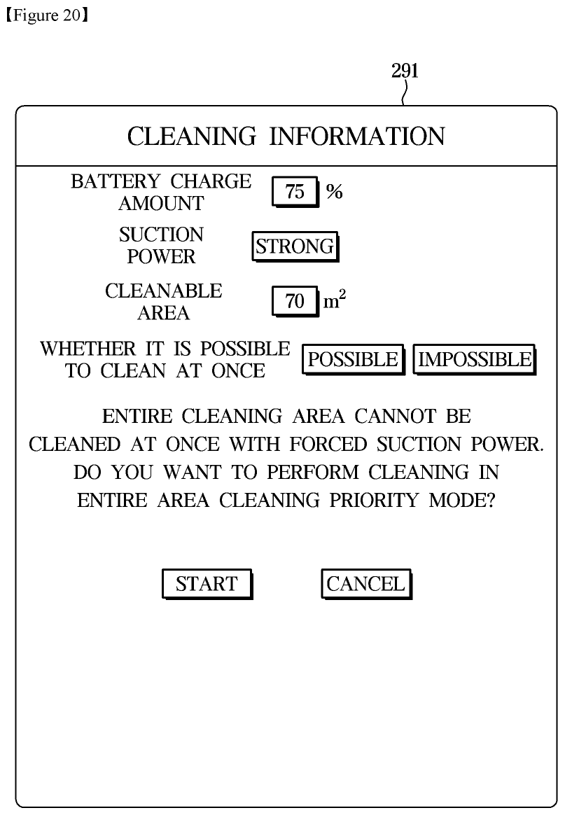

FIGS. 19 and 20 are views illustrating that cleaning information for cleaning a cleaning area by a cleaning robot is displayed on a user apparatus to provide cleaning information to a user according to an embodiment.

Referring to FIG. 19, the cleaning robot 100 may obtain the cleaning information while cleaning the cleaning area and transmit it to the user apparatus 200, and the display 290 of the user apparatus 200 may provide the cleaning information to the user by displaying the received cleaning information.

As illustrated in FIG. 19, the display 290 of the user apparatus 200 may display the information about the battery charge amount of the cleaning robot 100 and the cleaning area that has been recently cleaned.

In addition, the display 290 may display a screen in which the strength of the suction power currently set in the cleaning robot 100 and the user can select the strength of the suction power, and may also display a screen through which the cleaning robot 100 can select whether to perform cleaning on the entire area of the cleaning space.

By inputting a control command for information displayed on the display 290 based on the method described above, the user may determine the strength of the suction power of the dust sucking fan 177 of the cleaning robot 100 or the wideness of the cleaning area for the cleaning robot 100 to perform cleaning. Accordingly, the information about the cleaning area performed based on the current battery charge amount of the cleaning robot 100 may be displayed on the display 290.

As illustrated in FIGS. 19 and 20, on the display 290 of the user apparatus 200, based on the current battery charge amount and the suction power strength of the dust sucking fan 177, whether or not the cleaning area can be cleaned at once may be displayed.

The user may adjust the suction power strength of the dust sucking fan 177 of the cleaning robot 100 or the cleaning area of the cleaning robot 100 based on the information displayed on the display 290.

Among display contents of the display 290 illustrated in FIGS. 19 and 20, redundant descriptions of only the display contents that are substantially the same as those described with reference to FIGS. 12 to 18 or different from the display contents will be omitted.

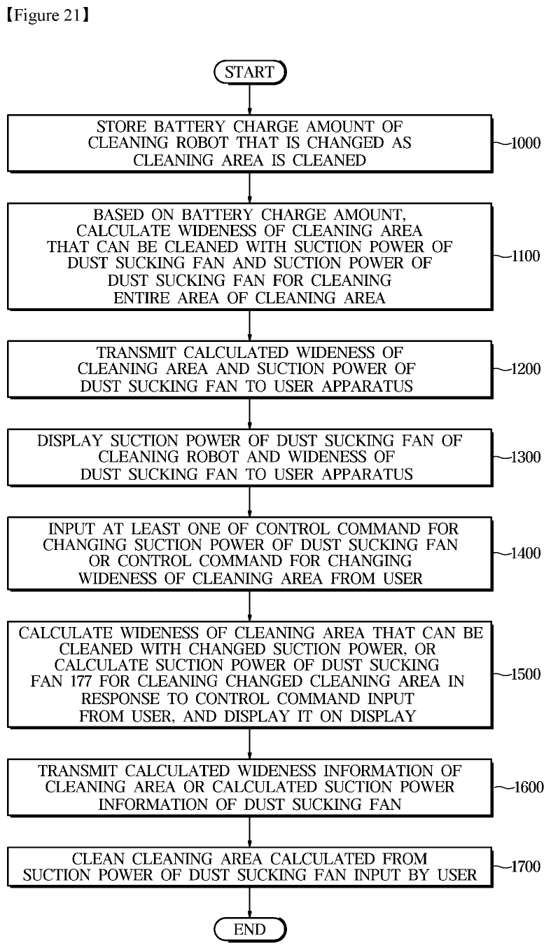

FIG. 21 is a flowchart illustrating a user apparatus and a cleaning control system of a cleaning robot according to an embodiment.

Referring to FIG. 21, the cleaning robot 100 may store the battery charge amount of the cleaning robot 100 that is changed as the cleaning area is cleaned in the storage 180 (1000).

Based on the current battery charge amount of the cleaning robot 100, the controller 110 of the cleaning robot 100 may calculate the wideness of the cleaning area that can be cleaned with the suction power of the dust sucking fan 177 and the suction power of the dust sucking fan 177 for cleaning the entire area of the cleaning area (1100).

The communication interface 150 of the cleaning robot 100 may transmit the information about the wideness of the cleaning area calculated by the controller 110 and the strength of the suction power of the dust sucking fan 177 to the user apparatus 200 (1200), the processor 250 of the user apparatus may control the display 290 to display the suction power information received from the cleaning robot 100 and the information about the wideness of the cleaning area on the display panel 291 (1300).

As described above with reference to FIGS. 12 to 18, the user may input at least one of control command for changing the suction power of the dust sucking fan 177 or the control command for changing the wideness of the cleaning area through the input 220 of the user apparatus 200 and the touch input to the display panel 291 (1400). In this case, the user may control the cleaning robot 100 to input the control command differently according to the mode in which the cleaning area is to be cleaned.

The processor 250 of the user apparatus 200 may calculate the wideness of the cleaning area that can be cleaned with the changed suction power, or calculate the suction power of the dust sucking fan 177 for cleaning the changed cleaning area in response to the control command input from the user, and display it on the display 290 (1500). Through this, the user may identify the cleaning-related control command input to the user apparatus 200.

The communication module 270 of the user apparatus 200 may transmit wideness information of the cleaning area or suction power information of the dust sucking fan 177 calculated in response to the control command input from the user to the cleaning robot 100 (1600).

The controller 110 of the cleaning robot 100 may control the moving device 160 and the cleaner 170 of the cleaning robot 100 to clean the cleaning area calculated in advance from the suction power of the dust sucking fan 177 input by the user based on the control command received from the user apparatus 200 by the communication interface 150 (1700).

That is, by cleaning the area of the cleaning area corresponding thereto with the suction power of the dust sucking fan 177 set according to the control command input by the user or the cleaning mode selected by the user, the cleaning robot 100 may perform cleaning on the cleaning area at once without recharging based on the current battery charge amount.

According to an embodiment of the disclosure, based on the current battery charge amount of the cleaning robot 100, there is an effect of securing an optimum cleaning effect without recharging the battery by adjusting the strength of the suction power of the dust sucking fan 177 and the area that can be cleaned.

In addition, by providing the information about the strength of the suction power of the cleaning robot 100 and the cleaning area to the user, there is an effect of controlling the cleaning to be performed in various cleaning patterns.

In addition, there is an effect that the user can control the cleaning robot 100 in an optimal cleaning mode by providing information such as the cleaning area and a required cleaning time to the user.

The disclosed embodiments may be implemented in the form of a recording medium storing computer-executable instructions that are executable by a processor. The instructions may be stored in the form of a program code, and when executed by a processor, the instructions may generate a program module to perform operations of the disclosed embodiments. The recording medium may be implemented non-transitory as a computer-readable recording medium.

The non-transitory computer-readable recording medium may include all kinds of recording media storing commands that can be interpreted by a computer. For example, the non-transitory computer-readable recording medium may be, for example, ROM, RAM, a magnetic tape, a magnetic disc, flash memory, an optical data storage device, etc.

Embodiments of the disclosure have thus far been described with reference to the accompanying drawings. It should be obvious to a person of ordinary skill in the art that the disclosure may be practiced in other forms than the embodiments as described above without changing the technical idea or essential features of the disclosure. The above embodiments are only by way of example, and should not be interpreted in a limited sense.

1. A cleaning robot comprising:
a dust sucking fan configured to suck dust from a cleaning area;
a dust sucking motor configured to rotate the dust sucking fan;
a communication interface configured to perform communication with a user apparatus;
a storage configured to store a battery charge amount of the cleaning robot that is changed as the cleaning area is cleaned; and
a controller configured to calculate a wideness of the cleaning area that can be cleaned with a suction power of the dust sucking fan based on the battery charge amount, and to control the cleaning robot to clean the cleaning area of the calculated wideness with the suction power of the dust sucking fan,
wherein the controller is configured to control the communication interface so that information about the wideness of the cleaning area that can be cleaned by the suction power of the dust sucking fan is transmitted to the user apparatus.

2. The cleaning robot according to claim 1, wherein the controller is configured to:
calculate the suction power of the dust sucking fan for cleaning an entire area of the cleaning area based on the battery charge amount, and
control the cleaning robot to clean the entire area of the cleaning area based on the calculated suction power.

3. The cleaning robot according to claim 2, wherein the controller is configured to control the communication interface so that information about the suction power of the dust sucking fan calculated to clean the entire area of the cleaning area is transmitted to the user apparatus.

4. The cleaning robot according to claim 1, wherein the controller is configured to:
divide the cleaning area according to a predetermined reference,
differently set the suction power of the dust sucking fan for each of the divided cleaning areas to clean an entire area of the cleaning area based on the battery charge amount, and
control the cleaning robot to clean each of the divided cleaning areas based on the set suction power.

5. The cleaning robot according to claim 1, wherein the communication interface is configured to receive a cleaning mode control command of the cleaning robot from the user apparatus.

6. The cleaning robot according to claim 5, wherein the controller is configured to:
in response to the received cleaning mode being a first mode for cleaning the entire area of the cleaning area, calculate the suction power of the dust sucking fan for cleaning the entire area of the cleaning area based on the battery charge amount, and
control the cleaning robot to clean the entire area of the cleaning area based on the calculated suction power.

7. The cleaning robot according to claim 5, wherein the controller is configured to:
in response to the received cleaning mode being a second mode for cleaning the cleaning area with a predetermined suction power of the dust sucking fan, calculate a wideness of the cleaning area that can be cleaned with the predetermined suction power based on the battery charge amount, and
control the cleaning robot to clean the calculated wideness of the cleaning area with the predetermined suction power.

8. The cleaning robot according to claim 1, wherein:
the storage is configured to store a battery consumption rate changed in response to a change in suction power of the dust sucking fan, the wideness of the cleaning area changed in response to the change in suction power of the dust sucking fan, and cleaning environment information of the cleaning area; and
the environmental information of the cleaning area comprises at least one of a moving distance of the cleaning robot in response to cleaning the cleaning area based on a state of a floor surface of the cleaning area, an obstacle located in the cleaning area, and the battery charge amount of the cleaning robot.

9. The cleaning robot according to claim 8, wherein the controller is configured to control the cleaning robot to clean the entire area of the cleaning area based on the battery charge amount by controlling to clean the cleaning area by avoiding obstacles located in the cleaning area based on the environmental information of the cleaning area stored in the storage.

10. A user apparatus comprising:
a communication module configured to communicate with a cleaning robot;
a display configured to display a suction power of a dust sucking fan of the cleaning robot and a wideness of a cleaning area; and
a processor configured to calculate the wideness of the cleaning area that can be cleaned with the changed suction power in response to a change in suction power of the dust sucking fan, or to calculate the suction power of the dust sucking fan for cleaning the changed cleaning area in response to a change in the wideness of the cleaning area to be displayed on the display.

11. The user apparatus according to claim 10, wherein the display is configured to:
display the suction power of the dust sucking fan and the wideness of the cleaning area in a form of a progress bar, and
change and display the displayed progress bar in response to a touch command on the process bar input from a user.

12. The user apparatus according to claim 11, wherein the display is configured to:
in response to a change in the display of the suction power of the displayed dust sucking fan according to the touch command input from the user, display the wideness of the cleaning area that can be cleaned in response to the changed suction power based on the battery charge amount of the cleaning robot, and
in response to a change in the display of the wideness of the displayed cleaning area according to the touch command input from the user, display the suction power of the dust sucking fan that is changed to clean the changed cleaning area with the battery charge amount of the cleaning robot.

13. The user apparatus according to claim 10, further comprising:
an input configured to receive at least one of a control command to change the suction power of the dust sucking fan or a control command to change the wideness of the cleaning area from a user.

14. The user apparatus according to claim 13, wherein:
the input is configured to receive a first mode for cleaning an entire area of the cleaning area;
in response to the input of the first mode, the processor is configured to control to be displayed on the display by calculating the suction power of the dust sucking fan for cleaning the entire area of the cleaning area based on the battery charge amount of the cleaning robot;
the input is configured to receive a second mode for cleaning the cleaning area with a predetermined suction power of the dust sucking fan; and
in response to the input of the second mode, the processor is configured to control to be displayed on the display by calculating the wideness of the cleaning area that can be cleaned with the predetermined suction power based on the battery charge amount of the cleaning robot.

15. The user apparatus according to claim 10, wherein the processor is configured to control the communication module so that wideness information of the cleaning area calculated in response to the change in suction power of the dust sucking fan or suction power information of the dust sucking fan calculated in response to the change in the wideness of the cleaning area is transmitted to the cleaning robot.
